(19) United States
(12) Patent Application Publication
(10) Pub. No.: US 2010/0202781 A1
(43) Pub. Date: Aug. 12, 2010

(54) Tunable Optical Transceiver in an XFP Package

(75) Inventor: Clay E. Hudgins, Madison, AL (US)

Correspondence Address: EMCORE CORPORATION, 1600 EUBANK BLVD, S.E., ALBUQUERQUE, NM, 87123, US

(73) Assignee: EMCORE Corporation, Albuquerque, NM (US)

(21) Appl. No.: 12/369,561

(22) Filed: Feb. 11, 2009

(51) Int. Cl. H04B 10/00

(52) U.S. Cl. 398/135

(57) ABSTRACT

An optical transceiver for converting and coupling an information-containing electrical signal with an optical fiber including a housing including an electrical connector with a serial interface for coupling with an external electrical cable or information system device and a fiber optic connector adapted for coupling with an external optical fiber, at least one electro-optical subassembly in the housing for converting between an information containing electrical signal and a modulated optical signal corresponding to the electrical signal including a transmitter subassembly including a tunable laser operating at selectable wavelength and modulated with the electrical signal for emitting a laser light beam coupled to the fiber optic connector for transmitting the optical signal to an external optical fiber.

### REFERENCE TO RELATED APPLICATIONS

This application is related to co-pending U.S. patent application Ser. No. 11/510,157 filed Aug. 25, 2006, now U.S. Pat. No. 7,325,983 assigned to the common assignee.

### BACKGROUND OF THE INVENTION

1. Field of the Invention

The invention relates to optical transceivers, and in particular to XFP form factors and Ethernet (IEEE 802.3ae standard), Synchronous Optical Network (SONET), and International Telecommunications Union Synchronous Digital Hierarchy (SDH) compliant transceivers that provide a high speed communications link between computers or communications units over optical fibers, such as used in high throughput fiber optic communications links in local area networks (LAN) and wide area networks (WAN), storage networks, and long distance telecommunication networks using SDH and SONET.

2. Description of the Related Art

A variety of optical transceivers are known in the art which include an optical transmit portion that converts an electrical signal into a modulated light beam that is coupled to a first optical fiber, and a receive portion that receives a second optical signal from a second optical fiber and converts it into an electrical signal.

Optical transceivers are packaged in a number of standard form factors which are “hot pluggable” into the chassis of the communications data system unit. Standard form factors provide standardized dimensions and electrical and optical input/output interfaces that allow devices from different manufacturers to be used interchangeably. Some of the most popular form factors include XENPAK (see www.xenpak.org), X2 (see www.X2msa.org), SFF (“small form factor”), SFP (“small form factor pluggable”), and XFP (“10 Gigabit Small Form Factor Pluggable”, see www.XFPMSA.org), and 300 pin MSA (Multisource Agreement) (see www.300pinMSA.org).

Although these conventional widely tunable designs have been used successfully in the past for 300 pin MSA formats, continued miniaturization is an ever-constant objective in the industry. It is desirable to miniaturize the size of 300 pin MSA tunable transceivers in order permit greater port density associated with the electrical network connection, such as, for example, the input/output ports of switch boxes, cabling patch panels, wiring closets, and computer I/O interfaces.

The XFP module is a hot-pluggable, serial-to-serial optical transceiver that commonly supports SONET OC-192, 10 Gigabit Ethernet, 10-Gbit/s Fibre Channel, and G.709 links. The module is 78 mm in length, 18.4 mm in width, and 8.5 mm in height. This small size limits the amount of electrical circuitry that can be implemented in the package, and consequentially in the prior art the majority of electronic signal processing is located in devices on the host board (inside the computer or network unit) rather than within the module in current commercial XFP devices. The XFP form factor features a serial 10 Gbit/s electrical interface called XFI that assumes that the majority of electronic signal processing functions are located within the circuits or ASICs on the system printed circuit board rather than within the optical transceiver module. Since the electronic processing defines the communication protocol, the XFP module is potentially protocol independent, and current implementations are in-fact protocol independent to varying degrees.

Prior to the present invention, there has not been a tunable laser transceiver for high speed (10 Gigabits/sec. or more) optical transmission in a very small (XFP type) form factor.

### SUMMARY OF THE INVENTION

1. Objects of the Invention

It is an object of the present invention to provide an improved high speed optical transceiver using a tunable laser in a small pluggable standardized form factor. It is also another object of the present invention to provide an optical transceiver in an XFP form factor for use in an optical fiber transmission system.

It is still another object of the present invention to provide an optical transceiver for use in an optical wavelength division multiplexed (WDM) transmission system suitable for short range and long haul applications using multiple semiconductor laser chips and a serial electrical interface.

Some implementations may achieve fewer than all of the foregoing objectives.

2. Features of the Invention

Briefly, and in general terms, the present invention provides an optical transceiver for converting and coupling an information-containing electrical signal with an optical fiber including a housing including an electrical connector with a serial interface for coupling with an external electrical cable or information system device and a fiber optic connector adapted for coupling with an external optical fiber, at least one electro-optical subassembly in the housing for converting between an information containing electrical signal and a modulated optical signal corresponding to the electrical signal including a transmitter subassembly including a tunable laser operating at a selectable wavelength and modulated with the electrical signal for emitting a laser light beam coupled to the fiber optic connector for transmitting the optical signal to an external optical fiber.

Additional objects, advantages, and novel features of the present invention will become apparent to those skilled in the art from this disclosure, including the following detailed description as well as by practice of the invention. While the invention is described below with reference to preferred embodiments, it should be understood that the invention is not limited thereto. Those of ordinary skill in the art having access to the teachings herein will recognize additional applications modifications and embodiments in other fields, which are within the scope of the invention as disclosed and claimed herein and with respect to which the invention could be of utility.

### BRIEF DESCRIPTION OF THE DRAWINGS

These and other features and advantages of this invention will be better understood and more fully appreciated by reference to the following detailed description when considered in conjunction with the accompanying drawings, wherein:

FIG. 1 is a perspective view of an optical transceiver module in which an exemplary embodiment in accordance with aspects of the present invention may be implemented;

FIG. 2 is an exploded perspective view of an optical transceiver module in accordance with aspects of the present invention may be implemented; and

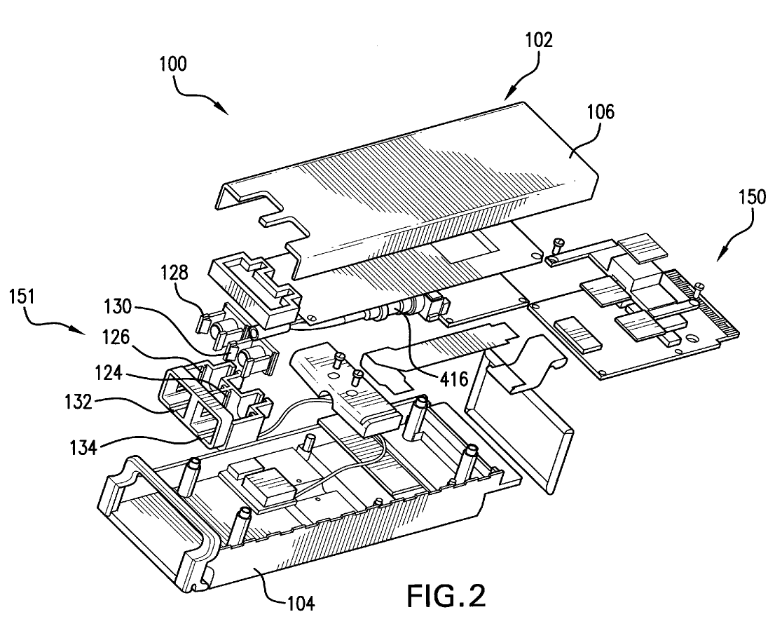

The novel features and characteristics of the invention are set forth in the appended claims. The invention itself, however, as well as other features and advantages thereof, will be best understood by reference to a detailed description of a specific embodiment, when read in conjunction with the accompanying drawings.

### DESCRIPTION OF THE PREFERRED EMBODIMENT

Details of the present invention will now be described, including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of actual embodiments or the relative dimensions of the depicted elements, and are not drawn to scale.

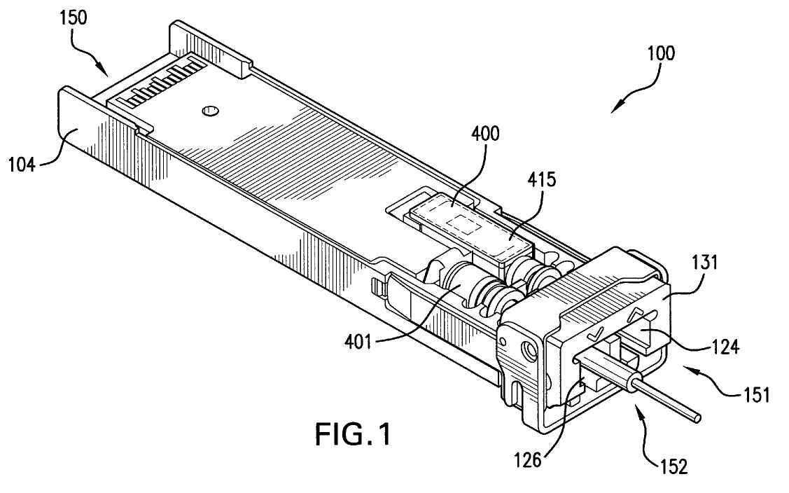

FIG. 1 is a perspective view of an optical transceiver module 100 in which an exemplary embodiment in accordance with aspects of the present invention may be implemented. In particular, FIG. 1 depicts the XFP form factor. In this particular embodiment, the module 100 is with the IEEE 802.3 sub-layer (PMD) or the X40 MSA (www.X40MSA.org) and is implemented in the XFP form factor having a length of 78 mm, a width of 18.35 mm, and a height of 8.5 mm. It is to be noted, however, that in other embodiments the transceiver module 100 may be configured to operate under various other standard protocols (such as Fibre Channel or SONET) and be manufactured in various alternate form factors such as XENPAK, X2, etc. The module 100 is preferably a 40 Gigabit Wide Wavelength Division Multiplexed (WWDM) transceiver compliant with the X40 MSA (4 channels×10 Gbps=40 Gbps) having four tunable lasers that operate at a selectable wavelength that enable minimum 2 km transmission of an optical signal over a single standard single mode fiber. The tunability of the lasers enables the module 100 to support the several wavelength options contemplated by the X40 MSA.

The transceiver module 100 includes a two-piece housing 102 including a base 104 and a cover 106. The base 104 is not illustrated in FIG. 1 for clarity. In addition, contact strips (not shown) may be provided to ground the module to an external chassis ground as well. The housing 102 is constructed of die-case or milled metal, preferably die-cast zinc, although other materials also may be used, such as specialty plastics and the like. Preferably, the particular material used in the housing construction assists in reducing EMI.

A first end of the housing 102 includes an electrical interface 150 with a serial electrical interface for coupling with an external electrical cable or information system device and for transmitting and/or receiving an information-containing electrical signal. In one embodiment, the electrical interface 150 includes an Infiniband interface.

A second end of the housing 102 includes an optical interface 151 fiber optic connector adapted for coupling with an external optical fiber 152 for transmitting and/or receiving an optical communications signal. The second end of the housing 102 includes a faceplate 131 for securing a pair of receptacles 124, 126. The receptacles, 124, 126 are configured to receive fiber optic connectors (not shown) which mate with optical plugs 128, 130 respectively. In the preferred embodiment, the connector receptacles 124, 126 are configured to receive industry standard LC duplex connectors. As such, keying channels 132, 134 are provided to ensure that the LC connectors are inserted into the receptacles 124, 126 in their correct orientation. Further, as shown in the exemplary embodiment and discussed further herein, the connector receptacle 124 is intended for an LC transmitter connector, and the connector receptacle 126 receives an LC receiver connector.

In one embodiment, the housing 102 holds three subassemblies or circuit boards, including a transmit board, a receive board, and a physical coding sublayer (PCS)/physical medium attachment (PMA) board, which is used to provide an electrical interface to external computer or communications units. An embodiment of the three subassemblies is disclosed in U.S. Pat. No. 7,325,983 herein incorporated by reference. The transmit subassembly includes one or more electro-optical subassemblies which may include a tunable laser module 400 and may be mounted in a single, hermetically sealed enclosure 415, which interfaces to a fiber coupling subassembly 416. The enclosure 415 is hermetically sealed to protect the tunable laser from humidity or other harsh environmental conditions. The enclosure 415 generally includes a rectangular shape with an electrical interface at a first end and an optical interface at a second end. The electrical interface may include one or more flex cables each with various connections. A photodectector module 401 is also positioned within the housing 102 and may be in the vicinity to the enclosure 415.

Each of the electro-optical subassemblies may include a tunable external cavity laser with a diode gain chip comprising a semiconductor diode laser with a partially reflective front facet and a substantially non-reflective rear facet. The tunable laser may also include a tunable filter, one or more collimating lenses, a reflective element, and an actuator to modulate the optical pathlength of the laser cavity. Possible implementations of the tunable filter include but are not limited to tunable Bragg gratings, tunable Fabry-Perot etalons, and tunable liquid crystal waveguides. Coupling optics and a modulator may also be positioned in the enclosure 415 along the optical path to provide isolation and data modulation. The coupling optics may include one or more collimating lenses and an optical isolator. The modulator may include a chip constructed from various semiconductor materials, such as indium phosphide based materials. A thermoelectric cooler may also be positioned within the enclosure 415 to control the heat of one or more of these elements. Examples of optical transmitters are disclosed in U.S. Pat. No. 7,257,142 and U.S. patent application Ser. No. ______ (Attorney Docket No. 8105/6009-026) filed on the same day as the present application, each of which is herein incorporated by reference.

In one embodiment, the transceiver module 100 is capable of tuning over 4 to 8 channels with a 100 GHz channel spacing, or over 16 channels with a 50 GHz spacing. The transceiver module 100 may also use optical non-return-to-zero (NRZ) optical modulation.

Another embodiment of the transceiver module 100 is capable of tuning over 36 to 72 channels at a 100 GHz channel spacing, or over 72 to 144 channels. This embodiment may also use NRZ optical modulation.

One embodiment may be capable of tuning over the entire C and L band at 50 GHz spacing, or over either the C or L band at 25 GHz spacing. The embodiment may use NRZ optical modulation, and may be capable of advanced optical modulation such as differential phase shift keying (DPSK) or quadrature phase shift keying (QPSK).

Although the embodiment described above is a pluggable 40 Gigabit WWDM transceiver, the same principles are applicable in other types of optical transceivers suitable for operating over both multimode (MM) and single mode (SM) fiber using single or multiple laser light sources, single or multiple photodetectors, and an appropriate optical multiplexing and demultiplexing system. The design is also applicable to a single transmitter or receiver module at 10 Gbps, 40 Gbps, or some other rate, or a module as either a transmitter, receiver, or transceiver to communicate over different optical networks using multiple protocols and satisfying a variety of different range and distance goals.

Although in the depicted embodiment, the transceiver 100 is manufactured in a modular manner using three separate subassemblies mounted in the housing—a transmitter subassembly, a receiver subassembly, and a protocol processing board, with each subassembly or board having dedicated functions and electrically connected to each other using either flex circuitry or mating multipin connectors, land grid arrays, or other electrical interconnect devices, the invention may also be implemented in a transceiver having a single board or subassembly mounted inside the housing.

Various aspects of the techniques and apparatus of the present invention may be implemented in digital circuitry, or in computer hardware, firmware, software, or in combinations of them. Circuits of the invention may be implemented in computer products tangibly embodied in a machine-readable storage device for execution by a programmable processor, or on software located at a network node or website which may be downloaded to the computer product automatically or on demand. The foregoing techniques may be performed by, for example, a single central processor, a multiprocessor, one or more digital signal processors, gate arrays of logic gates, or hardwired logic circuits for executing a sequence of signals or program of instructions to perform functions of the invention by operating on input data and generating output. The methods may advantageously be implemented in one or more computer programs that are executable on a programmable system including at least one programmable processor coupled to receive data and instructions from, and to transmit data and instruction to, a data storage system, at least one in/out device, and at least one output device. Each computer program may be implemented in a high-level procedural or object-oriented programming language, or in assembly or machine language if desired; and in any case, the language may be compiled or interpreted language. Suitable processors include, by way of example, both general and special purpose microprocessors. Generally, a processor will receive instructions and data from read-only memory and/or random access memory. Storage devices suitable for tangibly embodying computer program instructions and data include all forms of non-volatile memory, including by way of example, semiconductor devices, such as EPROM, EEPROM, and flash memory devices; magnetic disks such as internal hard disks and removable disks; magneto-optical disks; and CD-ROM disks. Any of the foregoing may be supplemented by or incorporated in, specially designed application-specific integrated circuits (ASICS).

It will be understood that each of the elements described above, or two of more together, also may find a useful application in other types of constructions differing from the types described above.

While the invention has been illustrated and described as embodied in an optical transceiver, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of the prior art, fairly constitute essential characteristics of the generic or specific aspects of this invention and, therefore, such adaptations should and are intended to be comprehended within the meaning and range of equivalence of the following claims.

1. An optical transceiver for converting and coupling an information-containing electrical signal with an optical fiber comprising:
a base member and a cover member forming an XFP pluggable module;
a housing including an electrical connector with a serial electrical interface for coupling with an external electrical cable or information system device and for transmitting and/or receiving an information-containing electrical signal, and a fiber optic connector adapted for coupling with an external optical fiber for transmitting and/or receiving an optical communications signal; and
at least one electro-optical subassembly in the housing for converting between an information-containing electrical signal and a modulated optical signal corresponding to the electrical signals including a transmitter subassembly including a tunable laser operating at a selectable wavelength and modulated with an electrical signals for emitting a light beam coupled to said fiber optic connector for transmitting the optical signal to an external optical fiber.

2. A transceiver as defined in claim 1, further comprising a communications protocol processing subassembly in the housing for processing the communications signal into a predetermined electrical or optical communications protocol.

3. A transceiver as defined in claim 1, wherein the electrical interface is an Infiniband interface.

4. A transceiver as defined in claim 1, wherein the transceiver is capable of tuning over 4 to 8 channels at a 100 GHz channel spacing, or over 16 channels at a 50 GHz channel spacing.

5. A transceiver as defined in claim 1, wherein the transceiver is capable of tuning over 36 to 72 channels at a 100 GHz channel spacing.

6. A transceiver as defined in claim 1, wherein the transceiver is capable of tuning over the entire C and L band at a 50 GHz spacing.

7. A transceiver as defined in claim 1, wherein the transceiver is capable of tuning over one of the C band and the L band at 25 GHz spacing.

8. A transceiver as defined in claim 1, wherein the transceiver is configured to use optical non-return-to-zero optical modulation.

9. A transceiver as defined in claim 1, wherein the transceiver is configured to use one of differential phase shift keying and quadrature phase shift keying.

10. An optical transceiver for converting and coupling an information-containing electrical signal with an optical fiber comprising:
a housing including an electrical connector for coupling with an external electrical cable or information system device for transmitting and/or receiving an information-containing electrical signal, and a fiber optic connector adapted for coupling with an external optical fiber for transmitting and/or receiving an optical communications signal, wherein the housing forms a pluggable module conforming to the XFP Multi Source Agreement; and
at least one electro-optical subassembly in the housing for converting between information-containing electrical signals and modulated optical signals corresponding to the electrical signals including a tunable laser operating at a selectable wavelength and modulated with the electrical signals for emitting a laser light beam coupled to said fiber optic connector for transmitting the optical signal to said external optical fiber.

11. A transceiver as defined in claim 10, wherein the electro-optical subassembly includes at least one additional tunable laser operating at other selectable wavelengths and modulated with the electrical signals for emitting additional laser light beams coupled to said fiber optic connector.

12. A transceiver as defined in claim 10, wherein the electrical interface is a single line serial electrical interface.

13. A transceiver as defined in claim 10, wherein the housing includes a two piece construction including a base and a cover.

14. A transceiver as defined in claim 10, wherein the electro-optical subassembly is hermetically sealed in an enclosure positioned within the housing.

15. An optical transceiver for converting and coupling an information-containing electrical signal with an optical fiber comprising:
a generally rectangular housing having a length of 78 mm, a width of 18.35 mm, and a height of 8.5 mm;
an electrical connector positioned at a first end of the housing, the electrical connector including a single line serial electrical interface for coupling with an external electrical cable or information system device for transmitting and/or receiving an information-containing electrical signal;
a fiber optic connector positioned at a second end of the housing and adapted for coupling with an external optical fiber for transmitting and/or receiving an optical communications signal;
an electro-optical subassembly in the housing for converting between an information-containing electrical signal and a modulated optical signal corresponding to the electrical signals, said electro-optical subassembly including a tunable laser operating at a selectable wavelength and modulated with electrical signals for emitting a laser light beam coupled to said fiber optic connector for transmitting the optical signal to the external optical fiber.

16. A transceiver as defined in claim 15, wherein the electro-optical subassembly includes a transmitter subassembly.

17. A transceiver as defined in claim 15, wherein the housing includes a two-piece construction including a base and a cover.

18. A transceiver as defined in claim 15, wherein the optical connector includes a faceplate with a pair of receptacles.

19. A transceiver as defined in claim 15, wherein the electrical connector is an XFI electrical interface.

20. A transceiver as defined in claim 15, wherein the transceiver is capable of tuning over 4 to 8 channels at a 100 GHz channel spacing, or over 16 channels at a 50 GHz channel spacing.

21. A transceiver as defined in claim 15, wherein the transceiver is capable of tuning over 36 to 72 channels at 100 GHz spacing.

22. A transceiver as defined in claim 15, wherein the transceiver is capable of tuning over the entire C and L band at 50 GHz spacing.
